(19) United States
(12) Patent Application Publication
(10) Pub. No.: US 2007/0107488 A1
(43) Pub. Date: May 17, 2007

(54) System and method for enabling calibration of sensors used for detecting leaks in compartments

(76) Inventor: Scott Farrell, Brentwood, TN (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/588,075

(22) Filed: Oct. 26, 2006

Related U.S. Application Data
(60) Provisional application No. 60/730,429, filed on Oct. 26, 2005.

(51) Int. Cl. G01D 18/00

(52) U.S. Cl. 73/1.01

(57) ABSTRACT

A system for enabling calibration of sensors used for detecting leaks in compartments comprising a structure, a sensor, a test manager, an arm, a transducer, and logic. The sensor is mounted on the structure, and the test manager is configured to provide an indication as to whether a compartment has an abnormal leak based on data from the sensor. The data is indicative of an amount of acoustic energy sensed by the sensor within a specified frequency range while a transmitter in the compartment is emitting acoustic energy within the specified frequency range. The arm is detachably coupled to the sensor, and the transducer is mounted on the arm. The logic is configured to cause the transducer to emit acoustic energy within the specified frequency range thereby enabling the sensor to be calibrated without removing the sensor from the structure.

### CROSS REFERENCE TO RELATED APPLICATION

This application claims priority to U.S. Provisional Application No. 60/730,429, entitled “Sensor Calibrating System and Method,” and filed on Oct. 26, 2005, which is incorporated herein by reference.

### RELATED ART

In the manufacture or repair of products that include a sealed compartment, various methods have been used to determine how well the compartment is sealed, and where water or air intrusion (or extrusion) might occur. In the case of vehicles, for example, it is important to verify that water will not leak into the passenger compartment. Since visual inspection can be highly unreliable, certain vehicle manufacturers utilize spray booths for subjecting fully assembled vehicles to an intense water spray to ensure that vehicles shipped from the factory will not leak due to faulty or damaged seals. While this type of testing can be fairly reliable, it requires a worker to check for the presence of water in the compartment, and it is destructive in the sense that it can cause significant water intrusion in poorly sealed vehicles, or in vehicles where a window or door has been inadvertently left partially open, requiring significant expenditure of time and material for repairs due to water damage. Additionally, the spray booths are expensive to install and maintain, and cannot be easily duplicated at vehicle service and repair facilities.

In attempts to alleviate some of the problems associated with spray booths, some leak detection systems employ ultrasonic sensors to non-destructively detect leaks within vehicles. U.S. Pat. No. 6,983,642 entitled “System and Method for Automatically Judging the Sealing Effectiveness of a Sealed Compartment,” which is incorporated herein by reference, describes one such leak detection system. In this regard, at least one ultrasonic transmitter is placed within the passenger compartment of a vehicle and emits ultrasonic energy. Ultrasonic sensors on the outside of the vehicle are used to determine the levels of ultrasonic energy within a close proximity of the vehicle. Ultrasonic energy may escape from the vehicle through a leak causing an increased amount of ultrasonic energy external to the vehicle at or close to the location of the leak. Thus, by detecting the increased ultrasonic energy, a sensor can detect the presence of the leak.

Unfortunately, manufacturing an efficient and reliable leak detection system that utilizes non-destructive ultrasonic sensing capabilities can be difficult and expensive. Further, it is contemplated that a convenient location for a leak detection system is on or close to an assembly line of a vehicle manufacturer. Such an environment can be extremely noisy and, therefore, adversely affect the performance of the leak detection system. Moreover, better and less expensive leak detection systems and methods capable of non-destructively detecting leaks of sealed compartments, such as passenger compartments of vehicles, are generally desirable.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1A depicts an exemplary leak detection system.

FIG. 1B depicts a front view of an exemplary leak detection system, such as is depicted in FIG. 1A.

FIG. 2 depicts an exemplary embodiment of a sensor for the leak detection system of FIG. 2.

FIG. 3 depicts an exemplary calibrator for calibrating the sensor of FIG. 2.

FIG. 4 depicts a side view of a calibrator port depicted n FIG. 2.

FIG. 5 depicts a side view of a calibrator connector depicted in FIG. 3.

FIG. 6 depicts the sensor of FIG. 2 and the calibrator of FIG. 3 positioned for sensor calibration in accordance with one embodiment of the present disclosure.

FIG. 7 is a block diagram illustrating an exemplary arrangement of circuit elements for sensor calibration, such as may be performed by elements from the sensor of FIG. 2 and the calibrator of FIG. 3.

FIG. 8 is a flow chart illustrating an exemplary method for sensor calibration.

FIG. 9 depicts an exemplary sensor and calibrator positioned for sensor calibration in accordance with one embodiment of the present disclosure.

FIG. 10 is a block diagram illustrating portions of the sensor and calibrator depicted in FIG. 9.

### DETAILED DESCRIPTION

The present disclosure generally pertains to sensor calibrating systems and methods for enabling calibration of sensors, which may be used in a variety of applications including reliably detecting leaks in sealed compartments, such as compartments within vehicles. In several embodiments of the present disclosure, an apparatus having a sealed compartment, such as a vehicle (e.g., automobile, airplane, etc.), is moved past at least one ultrasonic sensor. An ultrasonic transmitter is placed in the sealed compartment and emits acoustic energy as the apparatus is moved past the ultrasonic sensors. A leak can be automatically and non-destructively detected by analyzing data from the ultrasonic sensors.

For purposes of illustration, the calibration systems and methods of the present disclosure will be described hereafter as calibrating sensors for detecting leaks within sealed compartments, such as passenger compartments or trunks, of vehicles (e.g., automobiles, aircraft, boats, etc.). It is to be understood, however, that the calibration systems and methods of the present disclosure may be similarly used to calibrate other sensors.

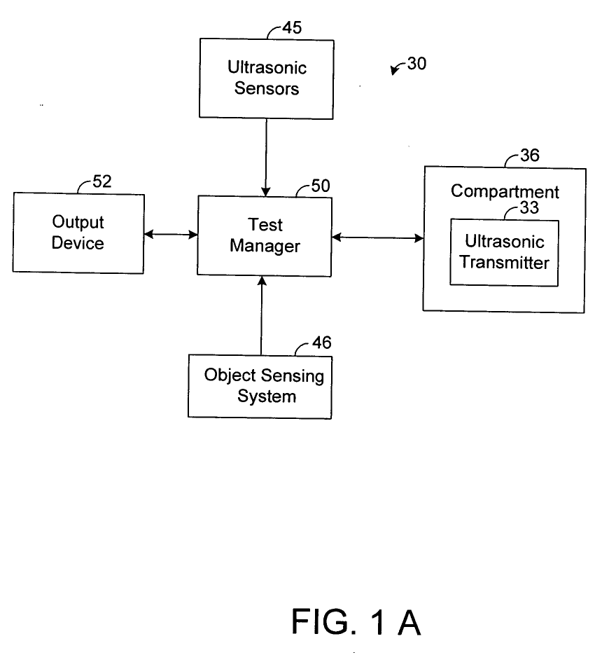

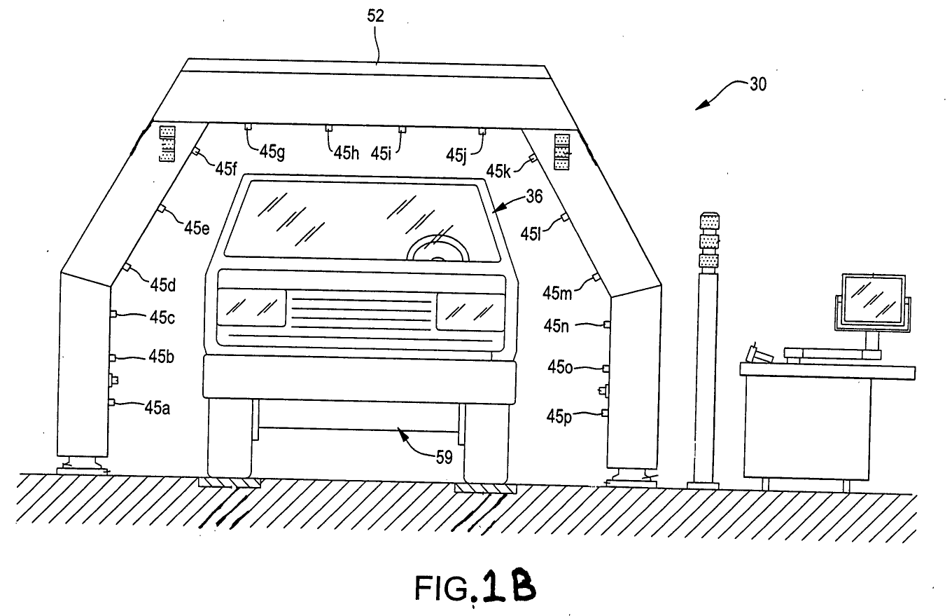

FIGS. 1A and 1B depict an exemplary leak detection system 30 that tests for abnormal compartment leaks. The system 30 comprises an ultrasonic transmitter 33 that is placed within a compartment 36, such as a passenger compartment of a vehicle 59. The compartment 36 is moved past ultrasonic sensors 45 tuned to the frequency of the transmitter 33. For example, ultrasonic sensors 45a-p (FIG. 1B) may be mounted on an arch-shaped support structure 52, and the vehicle 59 may be passed through the arch formed by the structure 52. The structure 52 may have other shapes in other embodiments.

In one exemplary embodiment, the transmitter 33 emits ultrasonic energy at approximately 40 kilo-Hertz (kHz), although other frequencies are possible in other embodiments. An object sensing system 46 detects a location of the vehicle 59 during the test, and ultrasonic sensors 45 detect ultrasonic energy, if any, that escapes from the compartment 36 as it is moved past the sensors 45. Based on the ultrasonic energy detected by the sensors 45, a test manager 50 determines whether the compartment 36 has any abnormal leaks. Further, by analyzing the data from the sensors 45 relative to the position of the vehicle compartment 36 during the test, the test manager 50 identifies a location of each abnormal leak detected by the system 30. The test manager 50 displays data indicative of the identifier location and/or other information about the detected leak via an output device 52, such as a printer or monitor. Exemplary embodiments of the system 30 are described in commonly-assigned U.S. Patent Application (attorney docket no. 731701-1050) entitled, “System and Method for Detecting Leaks in Sealed Compartments,” and filed on Oct. 25, 2006, which is incorporated herein by reference.

In order for the leak detection system 30 to more consistently and accurately detect leaks, it is desirable for the sensors 45 to be calibrated. In general, the components of an ultrasonic sensor, such as sensors 45, have parameters that vary with time thereby causing undesirable variations in measurements. Conventional techniques for calibrating electronic devices, similar to the sensors 45, include removing the sensors and using calibration instruments within an equipment servicing laboratory. However, due to the time and effort required to remove the sensors and the possible undesirable amount of downtime for the test line, as well as other factors, there is a need for improved calibration techniques.

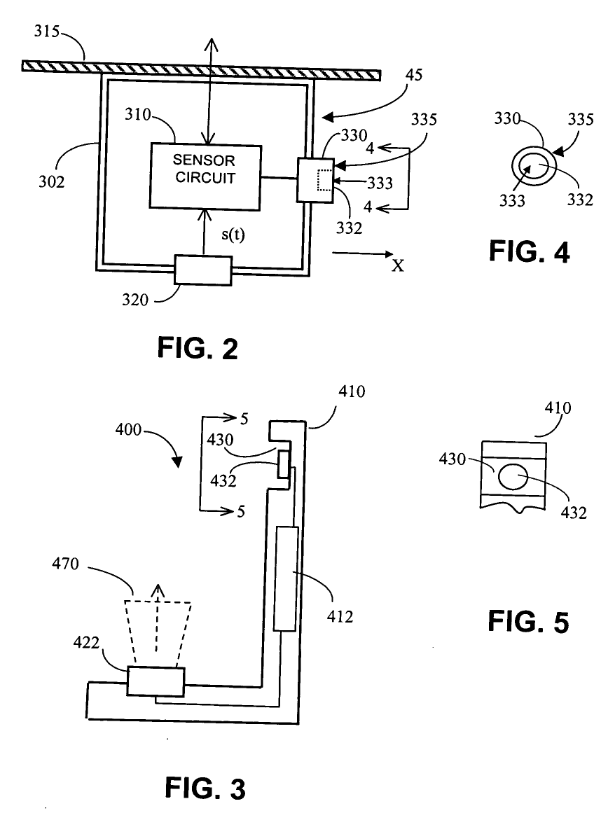

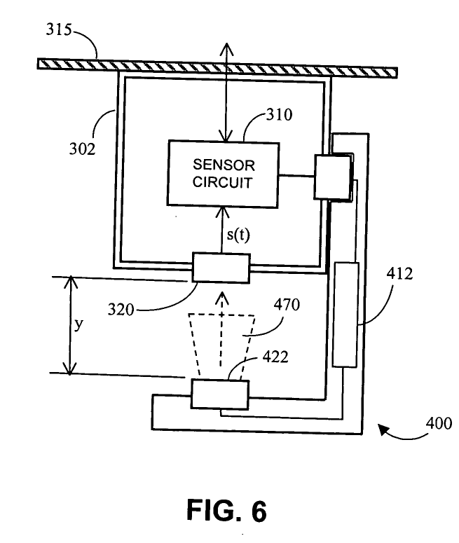

An exemplary embodiment of a sensor 45 is depicted in FIG. 2. The sensor 45 has a housing 302 mounted on a structure 315. When the sensor 45 is implemented in the leak detection system 30 depicted by FIG. 1B, the structure 315 depicted by FIG. 2 may be a portion of the structure 52 depicted by FIG. 1B. The sensor 45 has a calibrator port 335 attached to the housing 302. Note that the housing 302 can be any shape, such as rectangular. In addition, an exposed transducer 320 is attached to the housing 302. The transducer 320 can be shock mounted, if desired. The housing 302 houses a sensor circuit 310 and possibly other components not specifically shown in FIG. 2. A calibrator 400 adapted to connect with the calibrator port 335 is illustrated in FIG. 3. FIG. 6 shows the sensor 45 connected with the calibrator 400 to enable calibration of the sensor 45, as will be described in more detail hereinbelow.

Referring now to FIG. 2, the sensor 45, when used to test leakage from compartments in the system 30, senses ultrasonic energy from the transmitter 33. The sensor 45 has a sensor transducer 320 that converts ultrasonic energy from the transmitter 33 into a sensor signal, s(t). The sensor signal is received by a sensor circuit 310 that processes the signal so that the relative amount of ultrasonic energy detected by the sensor transducer 320 may be indicated (e.g., transmitted to a computer and/or displayed via an output device, such as a printer or monitor). The processing by the sensor circuit 310 may include amplifying, filtering and converting the signal to a digital format. In particular, an amplifier of the circuit 310 adjusts the amplitude of the sensor signal, and a filter of the circuit 310 removes out of band undesirable sound energy. Because the transmitter 33 typically provides an ultrasonic signal having a center frequency of around 40 kHz, the sensor transducer 320 selected preferably has a flat response at around 40 kHz and is responsive to any frequencies the transmitter 33 may emit. In one exemplary embodiment, a bandpass filter with a center frequency of about 40 kHz and a bandwidth of around 3 kHz equalized to the characteristics of the sensor transducer 320 helps to assure that undesirable sound noise is minimized. In the instant example, the output ultrasonic signal from the transmitter 33 may have frequencies in a range of approximately 39-41 kHz, although other frequency ranges are possible in other examples. Thus, the bandpass filter preferably has a flat shape for that frequency range. The amplifier gain, providing amplification in the sensor circuit 310, is a design parameter dependent on the expected strength of the sensor signal and the interface requirements for coupling information to output devices.

When the leak detection system 30 is checking for leaks, the sensor circuit 310 processes the sensor signal and a processed signal is forwarded to the test manager 50 to determine if an abnormal leak is detected. As previously indicated, in order for the leak detection system 30 to operate reliably, it is desirable for the sensor 45 to operate reliably during testing. Because the electronic and electrical components of the sensor 45 have parameters that can change with time (a normal occurrence with aging), the calibrator 400 is preferably used to periodically evaluate and adjust the sensor 45. A sensor port 335 (FIG. 2) is comprised of a sensor connector 330 with a sensor electrical plug 332 as shown on one side of the sensor 45. The sensor connector 330 and sensor plug 332 are adapted to receive the calibrator 400 (FIG. 3), as depicted by FIG. 6.

The calibrator 400 has an arm 410 that, as shown in FIG. 3, is generally “L-shaped,” although other shapes are possible in other embodiments. One end of the arm 410 forms a calibrator connector 430 having a calibrator plug 432, also shown in FIG. 5. The calibrator connector 430 and calibrator plug 432 are adapted to make a secure but detachable mechanical and electrical coupling to the sensor connector 330 and sensor plug 332, although having separate mechanical and electrical connections are possible in other embodiments. In this regard, as shown by FIGS. 2 and 4, the sensor connector 330 has a hollow region 333 in which the calibrator plug 432 fits. Further, the electrical plug 332 is exposed through this hollow region 333. When the plug 432 is inserted into the hollow region 333, the inner walls of the connector 335 defining the hollow region 333 counteract gravity forces and hold the calibrator 400. To detach the calibrator 400 from the sensor 45, the calibrator 400 can be pulled in the x-direction so that the plug 432 slides out of the connector 330. In other embodiments, other configurations of the connectors 330 and 430 are possible, and other techniques may be used to connect the calibrator 400 to the sensor 45. However, as described herein, it is generally desirable for the distance y to be precisely maintained. Thus, it is desirable for the connectors 330 and 430 to be configured, as is described herein, so that, if a secure connection is made, the transducer 422 is ensured to be precisely at the distance y from the transducer 320.

The electrical connection provided by plugs 332, 432 provides a power connection to the calibrator 400 from the sensor 45. In addition, the plugs 332, 432 provide at least for signal transfer from the sensor 45 to the calibrator 400 and may also provide an information loop for sending information to a central computer or system manager from the calibrator 400. For example, the calibrator 400 may communicate through the sensor 45 to the test manager 50. A calibrator circuit 412 is contained within an enclosure that forms the shape of the calibrator 400. In one embodiment, the calibrator circuit 412 has a signal generator, a driver (to excite a calibrator transducer 422), a comparator and evaluation logic. In other embodiments the calibrator may also have a processor, a display module, an input device, and other interface components, as well as other combinations of components. Note that the body of arm 410 can have any of a variety of cross-sectional shapes, such as circular, rectangular, etc.

In an exemplary embodiment, the signal generator of the calibrator circuit 412 provides a signal having a plurality of tones at different frequencies. For example, in one embodiment the signal has three tones of around 39 kHz, 40 kHz and 41 kHz, respectively, although other frequencies and numbers of tones are possible in other embodiments. Further, the tones may be transmitted simultaneously or in succession. The signal generator sends the tones to the driver of the calibrator circuit 412, which sends electrical energy to the calibrator transducer 422. Upon receiving the electrical energy from the driver, the transducer 422 emits ultrasonic energy 470 that is directed towards the sensor transducer 320. Because the transmitted ultrasonic energy 470 diverges, as illustrated by the conical shape, not all the transmitted ultrasonic energy is received and converted to electrical energy by the sensor transducer 320. The strength of the transmitted ultrasonic signal from transducer 422 is selected based on the dynamic range of energy expected at the sensor 45 when sensing energy leaks from the transmitter 33 of the leak detection system 30.

FIG. 6 shows the calibrator 400 electrically and mechanically coupled to the sensor 45. A distance y between the calibrator transducer 422 and the sensor transducer 320 is selected to limit the effect of noise (unwanted sound energy) on the calibration process. In this regard, placing the calibrator transducer 422 too close to the sensor transducer 320 may cause undesirable interference or feedback. Further, placing the transmitter too far from the sensor transducer 320 may reduce the strength of energy received by sensor transducer 320 to undesirable levels. Thus, the distance y is selected to optimize these considerations. For example, the calibrator 400 may be arranged such that the calibrator transducer 422 is positioned approximately as close as possible to the sensor calibrator 320 without causing feedback that significantly distorts the measurements of the calibration test. In one embodiment, the calibrator 400 is adapted such that the sensor transducer 320 is placed at a distance of about 20 centimeters from the calibrator transducer 422 when the calibrator 400 is coupled to the sensor 45, as shown by FIG. 6, although other distances are possible in other embodiments.

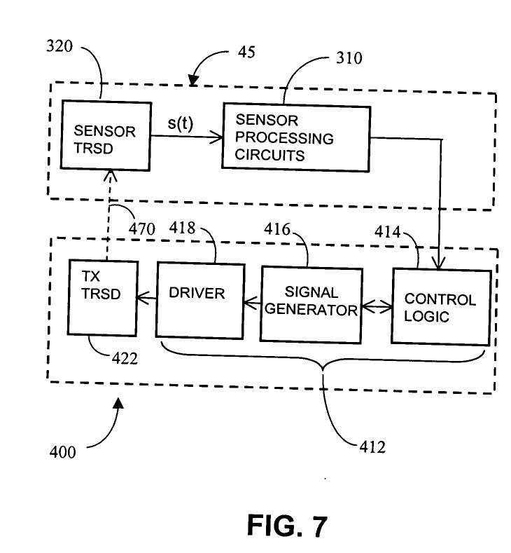

A circuit diagram illustrating exemplary functional elements of the calibrator system is shown in FIG. 7. As indicated above, power is supplied to the calibrator 400 by the sensor 45. For example, the sensor 45 may include a power source (not shown), such as a battery, and electrical power from this source may be provided to the calibrator components. In another embodiment, the power source may be external to the sensor 45, and a cable may be used to supply power from the power source to the sensor 45 and/or calibrator 400. In other embodiments, power may be supplied by a battery or other power supply of the calibrator 400.

As shown by FIG. 7, the calibrator circuit 412 comprises control logic 414, which may be implemented in hardware, software, or a combination thereof. When implemented in software, the circuit 412 may comprise an instruction execution device, such as a microprocessor, for executing instructions defined by the control logic 414.

After the calibrator circuit 412 receives power, control logic 414 in calibrator 400 directs the signal generator 416 to send three tones, as discussed above, to the driver 418. For each tone, electrical energy from the driver 418 excites the calibrator transducer (TRSD) 422 and ultrasonic energy 470 is transmitted. The frequency of the ultrasonic energy for each tone is different than the frequencies of the ultrasonic energy for the other two tones. The sensor transducer 320 receives a portion of the transmitted ultrasonic energy and converts that portion into a sensor signal, s(t). The sensor signal is processed by the sensor circuit 310 wherein the processing includes at least amplifying and filtering. The output of the sensor circuit 310 returns to the calibrator 400 and is received by the control logic 414. The control logic 414 has a monitoring and evaluation function that determines the energy level of each of the three tones coming from the sensor 45. If the ratio of the received values to the transmitted values for each tone is within a desired range, then the sensor 45 has passed the calibration test. However, if the ratios are outside a desired range, then the sensor 45 has failed the calibration test. Note that the desired range can be a function of the distance y. Moreover, connecting the calibrator 400 to the sensor 45, as shown by FIG. 6, ensures that the sensor transducer 320 is precisely at the expected distance, y, from the calibrator transducer 422. Thus, the desired range for the ratio of the received and transmitted values can be pre-computed and stored in the calibrator 400, or other location, prior to testing.

If the sensor 45 fails the calibration test, corrective action can be performed. For example, if the calibration test is failed, the control logic 414 can be configured to provide an output indicating that the test has been failed. As a mere example, one or more light indicators (not shown), such as light emitting diodes (LEDs), may be used to indicate whether the test has been passed or failed. Such indicators may be mounted on the arm 410 or elsewhere. Further, the corrective action may include tuning (an on-site action) the filter portion of the sensor circuit 310, replacing the sensor 45, or performing other actions. Corrective action may be done manually or automatically. For example, the sensor processing circuits 310 may include a component that, based on sample values indicating the measured level of acoustic energy, automatically adjusts the taps of one or more filters in an effort to tune the sensor 45 to the desired frequency or frequency range.

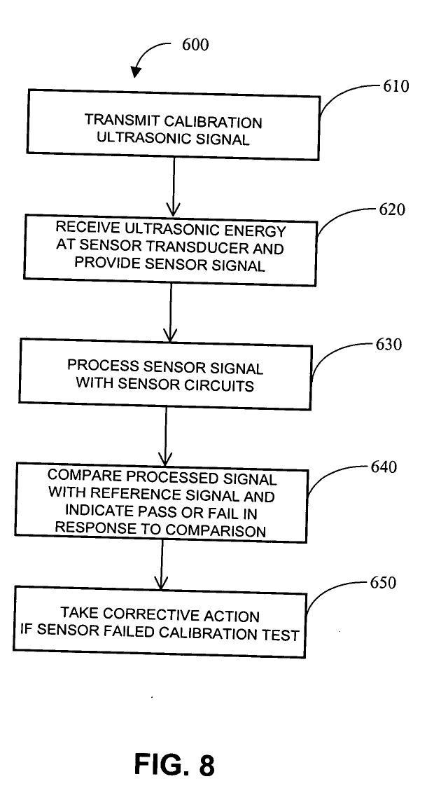

An exemplary method for sensor calibration is illustrated in FIG. 8. After the calibrator 400 is plugged into the sensor port 335, ultrasonic energy 470 is transmitted from the calibrator 400 towards the sensor 45, step 610. Because energy from the calibrator transducer 422 diverges, not all the transmitted ultrasonic energy arrives at the sensor transducer 320. The energy received by the sensor transducer 320 is converted to electrical energy as a sensor signal, step 620. The sensor signal is processed, step 630, by the sensor circuit 310 and returned to the calibrator 400. The processed signal is compared with the electrical signal transmitted from the calibrator 400 and logic in the control logic 414 determines if the sensor 45 has passed or failed, step 640. Corrective action is taken, step 650, if the sensor 45 fails the calibration test.

The corrective action taken may include adjusting a filter, such as an 8^{th} order filter, in the sensor 45 to change the frequency response of the filter. In a sensor system having a digital signal process, where a digital filter is used for processing, the characteristics of the filter may be changed by adjusting the values of the filter taps. Various other types of adjustments may be made in other embodiments. In this regard, the filter may be adjusted manually or logic in the calibrator 400 or sensor 45 may automatically determine and adjust the tap coefficients.

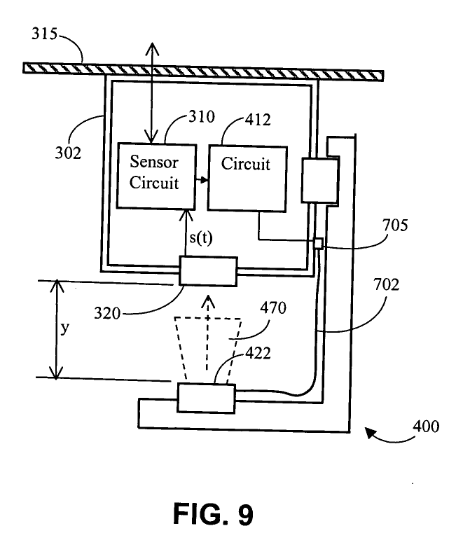

It should be noted that the embodiments described above are exemplary, and various modifications may be made to the described embodiments without departing form the principles of the present disclosure. As an example, FIG. 9 depicts an exemplary embodiment in which the calibrator circuit 412, including the control logic 414, signal generator 416, and driver 418, reside within the housing 302. Further, an electrical connection 702 is connected to the transducer 422 and an electrical interface 705, and this connection 702 provides a communication link with between the sensor 45 and the transducer 422. Yet other configurations are possible.

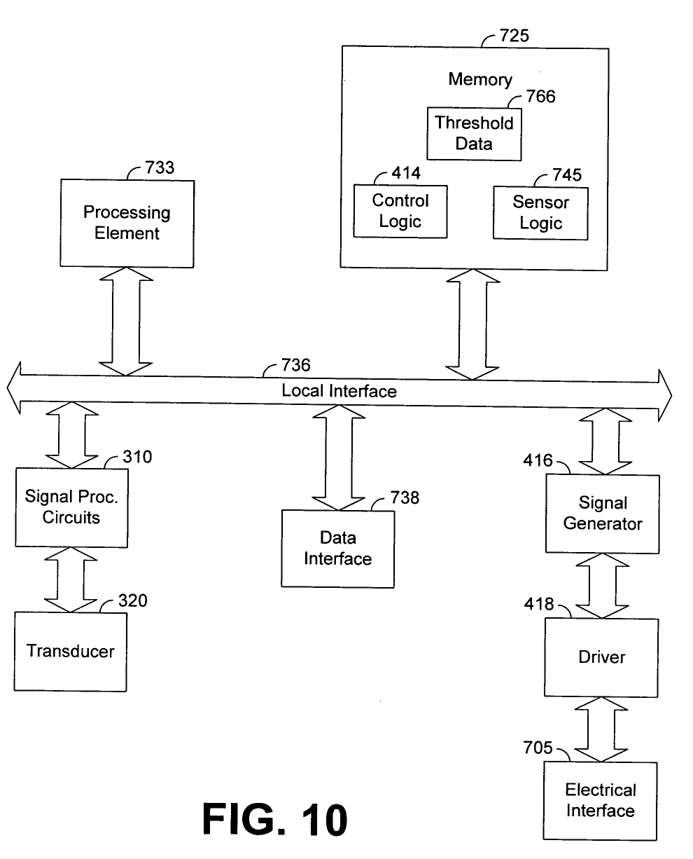

FIG. 10 depicts an exemplary block diagram for an embodiment in which the control logic 414, the signal generator 416, and the driver 418, reside within the housing 302. In the embodiment depicted by FIG. 10, the control logic 414 is implemented in software and stored within memory 725. In other embodiments, the control logic 414 can be implemented in hardware or a combination of hardware and software.

The exemplary embodiment depicted by FIG. 10 comprises at least one conventional processing element 733, such as a digital signal processor (DSP) or a central processing unit (CPU), that communicates to and drives the other elements the housing 302 via a local interface 736, which can include at least one bus. Furthermore, a data interface 738 is coupled to the interface 736 and used for communicating with the test manager 50 (FIG. 1B) of the leak detection system 30. As shown by FIG. 10, the signal generator 416 is also coupled to the interface 736, and the driver 418 is coupled to the signal generator 416, as well as the electrical interface 705. The transducer 320 is coupled to signal processing circuits 310, which processes signals from the transducer 320, such as performing filtering and amplification of such signals. Sensor logic 745 is shown as implemented in software and stored in memory 725, although the logic 745 can be implemented in hardware or a combination of hardware and software in other embodiments. The sensor logic 745 can perform various functions, such as communicating sample values from the transducer 320 to the test manager 50 when the sensor 45 is being used for testing a compartment for leaks.

In one exemplary embodiment, the control logic 414 is configured to use the data interface 738 to transmit data indicative of the calibration test results to the test manager 50. The test manager 50 then provides an output indicative of the test results.

For example, as described above, the test manager 50 may be configured to provide outputs indicative of leakage test results via an output device 52. This same output device 52 could be used to report calibration test results as well. Further, the reported test results could include more information than just whether the sensor 45 under test passed or failed the calibration test. For example, a value indicative of the extent of acoustic energy detected in the calibration test could be reported so that a user can be more informed about the calibration.

For illustrative purposes, assume that the desired transmit frequency of the transmitter 33 is about 40 kHz. In one exemplary embodiment, threshold data 766 defining at least one threshold for the calibration test is stored in memory 725. For example, in one embodiment, the threshold data 766 a threshold (TH). The threshold is based on the distance y, and is set to establish a minimum amount of acoustic energy that should be detected by the sensor 45 if a source of the energy is positioned a distance of y from the transducer 320. For example, if the transducer 320 detects acoustic energy from a source transmitting at a distance of y and a frequency of about 40 kHz, then the measured value of acoustic energy should exceed TH. If so, the sensor 45 is deemed to pass the calibration test for that frequency (i.e., 40 kHz). If not, the sensor 45 is deemed to fail the calibration test.

During calibration, the control logic 414 instructs the signal generator 416 to generate a signal for causing the transducer 422 to emit acoustic energy at about 40 kHz. The generated signal is amplified by driver 418 and transmitted to the transducer 422 via the electrical interface 705. In response, the transducer 422 emits acoustic energy at about 40 kHz. The transducer 320 senses the acoustic energy and generates an electrical signal, which is processed by the circuits 310 to produce a sample value indicative of the amount of acoustic energy detected by the transducer 320. The sample value is compared to the threshold (TH). If the sample value exceeds the threshold, the control logic 414 determines that the sensor 45 passes the calibration test. If the sample value is below the threshold, the control logic 414 determines that the sensor 45 fails the calibration test.

The control logic 414 transmits data indicative of the calibration test to the test manager 50, which then displays the data via output device 52. As an example, the displayed information may indicate the sample value from the test and/or an indication whether the sensor 45 passed the test. Further, the displayed information may indicate the difference between sample value and the threshold (TH). Other types of information are possible in other embodiments.

Moreover, other configurations of the calibrating system would be apparent to one of ordinary skill in the art upon reading this disclosure. For example, the arm 410 could be detachably coupled to the structure 52 or some, if desired, provided that the distance between the transducers 320 and 422 can be precisely controlled such that the transducer 422 is at the expected distance y from the transducer 320 when the arm 410 is secured to the structure 52.

1. A system for enabling calibration of sensors used for detecting leaks in compartments, comprising:
a structure;
a sensor mounted on the structure;
a test manager configured to provide an indication as to whether a compartment has an abnormal leak based on data from the sensor, the data indicative of an amount of acoustic energy sensed by the sensor within a specified frequency range while a transmitter in the compartment is emitting acoustic energy within the specified frequency range;
an arm detachably coupled to the sensor;
a transducer mounted on the arm; and
logic configured to cause the transducer to emit acoustic energy within the specified frequency range thereby enabling the sensor to be calibrated without removing the sensor from the structure.

2. The system of claim 1, wherein the sensor is configured to provide a value indicative of the acoustic energy emitted by the transducer, and wherein logic is configured perform a comparison between the value and a predefined threshold.

3. The system of claim 2, wherein the logic is configured to provide an output indicative of the comparison.

4. A method for enabling calibration of sensors used for detecting leaks in compartments, comprising the steps of:
sensing, via a sensor mounted on a structure, acoustic energy within a specified frequency range emitted by a transmitter within a compartment;
determining whether the compartment has an abnormal leak based on the sensing step;
detachably coupling an arm to the sensor or to the structure while the sensor is mounted on the structure, the arm having a transducer mounted thereon; and
causing the transducer to emit acoustic energy within the specified frequency range thereby enabling the sensor to be calibrated without removing the sensor from the structure.

5. The method of claim 4, further comprising the steps of;
sensing, via the sensor, the acoustic energy emitted by the transducer thereby providing a value indicative of the of the sensed acoustic energy emitted by the transducer, and
comparing the value to a predefined threshold.

6. The method of claim 5, wherein the predefined threshold is based on an expected distance of the transducer from the sensor, and wherein the detachably coupling step ensures that the transducer is at the expected distance from the transducer.
